(19) United States
(12) Patent Application Publication
(10) Pub. No.: US 2025/0175101 A1
(43) Pub. Date: May 29, 2025

(54) DRIVE DEVICE

(71) Applicant: TOYOTA JIDOSHA KABUSHIKI KAISHA, Toyota-shi (JP)

(72) Inventor: Wan Leng ANG, Susono-shi (JP)

(73) Assignee: TOYOTA JIDOSHA KABUSHIKI KAISHA, Toyota-shi (JP)

(21) Appl. No.: 18/800,519

(22) Filed: Aug. 12, 2024

(30) Foreign Application Priority Data
Nov. 27, 2023 (JP) 2023-200089

(51) Int. Cl. H02P 5/747; B60K 6/365; B60K 6/442

(52) U.S. Cl. CPC H02P 5/747; B60K 6/365; B60K 6/442

(57) ABSTRACT

The drive device disclosed herein includes a first motor including a first stator coil, a second motor including a second stator coil, a first inverter, a second inverter, a changeover switch, an interrupter switch, and a controller. The first inverter is connected to the first stator coil, and the second inverter is connected to the second stator coil. The changeover switch connects the first stator coil to one of a neutral point and the second inverter. The interrupter switch disconnects the second stator coil from the second inverter. The controller may switch between a dual mode in which the first stator coil is connected to the second inverter and the interrupter switch is opened, and a single mode in which the first stator coil is connected to the neutral point.

### CROSS-REFERENCE TO RELATED APPLICATION

This application claims priority to Japanese Patent Application No. 2023-200089 filed on Nov. 27, 2023, incorporated herein by reference in its entirety.

### BACKGROUND

### 1. Technical Field

The technology disclosed in the present specification relates to a drive device including two motors and two inverters.

### 2. Description of Related Art

An open winding motor, in which two inverters are connected to one motor, is known. One end of a stator coil of the open winding motor is connected to a first inverter, and the other end is connected to a second inverter. A drive device in which two inverters are connected to one open winding motor is sometimes referred to as a dual inverter type. In the dual inverter type, voltage applied to the stator coil can be increased as compared to a drive device using one inverter. The dual inverter type can output high torque with high utilization efficiency. Now, high utilization efficiency means low power loss. Japanese Unexamined Patent Application Publication No. 2023-25679 (JP 2023-25679 A) exemplifies a drive device of a dual inverter type.

### SUMMARY

There is known, with respect to battery electric vehicles and hybrid electric vehicles, a drive device including two motors, and two inverters connected to the respective motors (two-motor/two-inverter drive device). In conventional two-motor/two-inverter drive devices, each inverter drives each motor independently. For example, a first motor and a first inverter drive front wheels, and a second motor and a second inverter drive rear wheels.

The present specification improves the two-motor/two-inverter drive device such that it can also be used as a dual inverter, and provides a drive device with a broad range of application.

A drive device disclosed in the present specification includes a first motor equipped with a first stator coil, a second motor equipped with a second stator coil, a first inverter, a second inverter, a changeover switch, an interrupter switch, and a controller.
The first inverter is connected to the first stator coil, and
the second inverter is connected to the second stator coil.
The changeover switch connects the first stator coil to one of a neutral point and the second inverter.
The interrupter switch can disconnect the second stator coil from the second inverter.
The controller controls the changeover switch and the interrupter switch.
The controller can switch between a dual mode in which the first stator coil is connected to the second inverter by the changeover switch and also the interrupter switch is opened, and a single mode in which the first stator coil is connected to the neutral point by the changeover switch.
Note that in single mode, the interrupter switch may be either open or closed.

In single mode, the controller 40 can individually control the first motor (first inverter) and the second motor (second inverter). Single mode corresponds to a conventional two-motor/two-inverter type drive device. In dual mode, the first inverter and the second inverter are connected to the stator coil of the first motor. At this time, the drive device can be used as a dual inverter type drive device. In dual mode, high torque can be obtained from the first motor. The technology disclosed in the present specification can realize a drive device that can be used as either two-motor/two-inverter type or dual-inverter type. The drive device disclosed in the present specification has a broad range of application. In other words, the drive device disclosed in the present specification has good power utilization efficiency.

The first stator coil of the first motor may include a first sub-coil and a second sub-coil that are connected in series.
In this case, the changeover switch may be configured to connect an intermediate point between the first sub-coil and the second sub-coil to the neutral point.
Note that when connecting the first stator coil to the second inverter, ends of the serially connected arrangement of the first sub-coil and the second sub-coil are connected to the second inverter. In dual mode, the first sub-coil and the second sub-coil are used, and in single mode, only the first sub-coil is used. In dual mode, high torque is obtained. In single mode, inductance of the first motor is reduced since the number of turns of the coils used is smaller, and as a result, loss in high rotation range is reduced.

The drive device disclosed in the present specification may further include an engine and a planetary gear.
The first motor is coupled to a ring gear of the planetary gear, and
the second motor is coupled to a sun gear of the planetary gear.
The engine is coupled to a carrier of the planetary gear.
When dual mode is selected and the engine is turned off, higher torque is produced in EV mode. When single mode is selected and the engine and the second motor are stopped, the output torque is low, but high utilization efficiency can be obtained. Selecting single mode, and running the engine and also running the first motor and the second motor, is equivalent to a conventional hybrid system.

Details of the technology disclosed in the present specification and further improvements will be described in the “DETAILED DESCRIPTION OF EMBODIMENTS” below.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a circuit diagram of a drive device according to a first embodiment;

FIG. 2 is a circuit diagram of a drive device according to a second embodiment;

FIG. 3 is a block diagram of a drive device according to a third embodiment;

FIG. 4 is a collinear diagram of a drive device according to a third embodiment (single-mode/low-torque EV running);

FIG. 5 is a collinear diagram of a drive device according to a third embodiment (dual-mode/high-torque EV running); and

FIG. 6 is a collinear diagram of a drive device according to a third embodiment (single-mode/high-torque HV running).

### DETAILED DESCRIPTION OF EMBODIMENTS

### First Embodiment

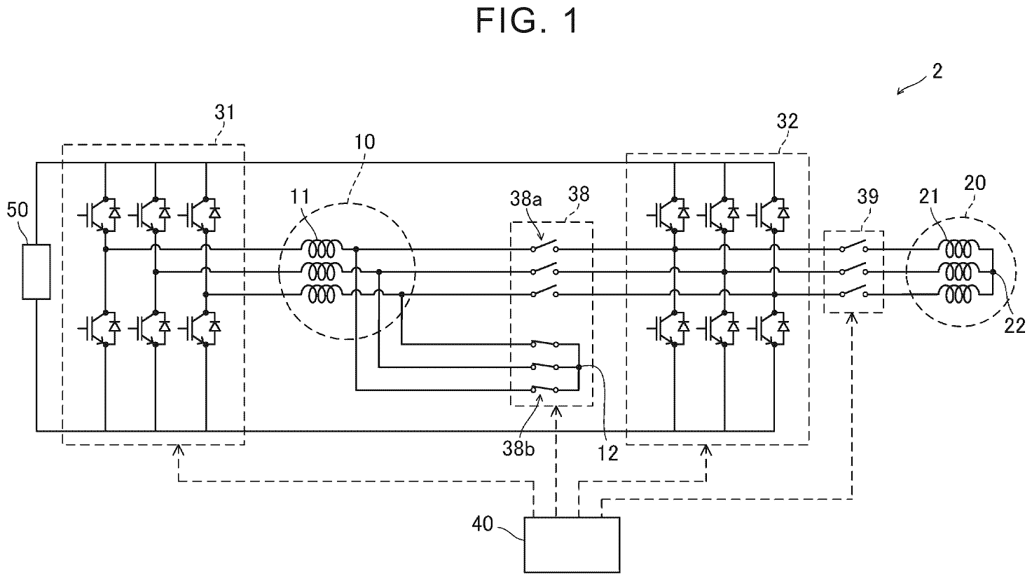

FIG. 1 is a circuit diagram of a drive device 2 according to a first embodiment. The drive device 2 includes a first motor 10, a second motor 20, a first inverter 31, a second inverter 32, a changeover switch 38, an interrupter switch 39, and a controller 40. The drive device 2 can output torque from each of the first motor 10 and the second motor 20, stop one of the first motor 10 and the second motor 20, and output torque from the other. The drive device 2 having two motor-output shafts is applied to a battery electric vehicle or a hybrid electric vehicle. In one battery electric vehicle, the first motor 10 drives the front wheels and the second motor 20 drives the rear wheels. In an exemplary hybrid electric vehicle, the first motor 10, the second motor, and the engine interlock with the wheels via the planetary gears. The drive device 202 suitable for hybrid electric vehicle will be described later.

The first inverter 31 includes three series connections of two switching elements. Three sets of series connections are connected in parallel to the DC power supply 50. The controller 40 controls the switching element. The dotted arrow line in FIG. 1 represents a signal line. When the controller 40 appropriately turns on and off the six switching elements, an alternating current is output from the intermediate point of the series connection. The second inverter 32 has the same circuit structure as the first inverter 31. Three sets of series connections of the second inverter 32 are also connected in parallel to the DC power supply 50. Since the structure of the inverter is well known, detailed description thereof will be omitted.

Each of the first motor 10 and the second motor 20 is a three-phase AC motor. Three AC terminals of the first inverter 31 are connected to the first motor 10. The first motor 10 includes three first stator coils 11, and each of the three AC ends of the first inverter 31 is connected to one end of each of the three first stator coils 11. The other end of the first stator coil 11 is connected to the second inverter 32 and the neutral point 12 via a changeover switch 38. The changeover switch 38 includes a first switch 38a and a second switch 38b. The first switch 38a is connected between the AC terminals of the first stator coil 11 and the second inverter 32, and the second switch 38b is connected between the first stator coil 11 and the neutral point 12. When the first switch 38a is closed, each of the first stator coils 11 is connected to a corresponding one of the AC terminals of the second inverter 32. When the first switch 38a is opened, the first stator coil 11 is disconnected from the second inverter 32. When the second switch 38b is closed, each of the first stator coils 11 is connected to the neutral point 12. The other ends of the plurality of first stator coils 11 are connected to each other at a neutral point 12. When the second switch 38b is opened, the first stator coil 11 is disconnected from the neutral point 12. The controller 40 controls the changeover switch 38.

The controller 40 is configured such that the first switch 38a and the second switch 38b are closed when one of them is opened. That is, the changeover switch 38 connects the other end of the first stator coil 11 to one of the neutral point and the second inverter 32. More specifically, the changeover switch 38 connects the other end of the first stator coil 11 to either one of the neutral point and the AC end of the second inverter 32.

Three AC ends of the second inverter 32 are connected to the second motor 20. The second motor 20 includes three second stator coils 21, and each of the AC ends of the second inverter 32 is connected to is connected to one end of each of the three second stator coils 21. The other ends of the plurality of second stator coils 21 are connected to each other at a neutral point 22. An interrupter switch 39 is connected between the AC end of the second inverter 32 and the second stator coil 21. When the interrupter switch 39 is opened, the second motor 20 is shut off from the second inverter 32.

The controller 40 controls the changeover switch 38 and the interrupter switch 39. The controller 40 closes the first switch 38a of the changeover switch 38, opens the second switch 38b, and opens the interrupter switch 39. At this time, the other end of the first stator coil 11 of the first motor 10 is connected to the AC end of the second inverter 32, and the second motor 20 is shut off from the second inverter 32. This state is hereinafter referred to as dual mode. At this time, the neutral point 12 is cut off from the first stator coil 11.

The controller 40 also opens the first switch 38a of the changeover switch 38 and closes the second switch 38b. At this time, the other end of the first stator coil 11 of the first motor 10 is cut off from the second inverter 32 and is connected to the neutral point 12. This state is hereinafter referred to as single mode. In the single mode, the interrupter switch 39 may be closed or open. When the interrupter switch 39 is closed, the second motor 20 is connected to the second inverter 32. The first motor 10 is driven by the first inverter, and the second motor 20 is driven by the second inverter 32. The first motor 10 and the second motor 20 are individually driven.

The controller 40 selects either the dual mode or the single mode. In the dual mode, the AC end of the first inverter 31 is connected to one end of the first stator coil 11, and the AC end of the second inverter 32 is connected to the other end of the first stator coil 11. When the controller 40 appropriately turns on and off the switching elements of the first inverter 31 and the second inverter 32, the first motor 10 outputs a high torque. The output of the first motor 10 at this time is larger than the output when one motor is driven by one inverter. The control rule of the two inverters in the dual mode may be a known technique.

In the dual mode, high utilization efficiency and high torque are obtained. Therefore, the high utilization efficiency means that the power loss at the time of motor driving is low. In the dual mode, the second motor 20 cannot be used.

In the single mode, the AC end of the first inverter 31 is connected to one end of the first stator coil 11, and the other end is connected to the neutral point 12 via the changeover switch 38. At this time, the first stator coil 11 is cut off from the AC terminal of the second inverter 32. When the interrupter switch 39 is closed, the AC end of the second inverter 32 is connected to the second stator coil 21 of the second motor 20. In the single mode, the first inverter 31 drives the first motor 10, and the second inverter 32 drives the second motor 20. In the single mode, the first motor 10 and the second motor 20 can be individually controlled. In the single mode, the maximum output torque of the first motor 10 is lower than that in the dual mode, but in the single mode, the two motors can be driven with high utilization efficiency.

In the drive device 2 of the first embodiment, the output torque is obtained with high utilization efficiency from the low torque band to the high torque band by switching between the dual mode and the single mode. Since the drive device 2 can switch between the dual mode and the single mode, the range of application is widened. In other words, the drive device 2 has high power utilization efficiency.

The drive device 2 is suitable for a battery electric vehicle (or hybrid electric vehicle) using two motors. In an application example of the drive device 2, one output shaft of the first motor 10 and the second motor 20 is coupled to the front wheel, and the other output shaft is coupled to the rear wheel.

In a battery electric vehicle in which four-wheel drive and two-wheel drive can be selected, the dual mode and the single mode are selectively used as follows. When traveling by four-wheel drive, the controller 40 selects a single mode. The controller 40 then closes the interrupter switch 39. The controller 40 controls the first inverter 31 and the second inverter 32. That is, the front wheels are driven by one of the first motor 10 and the second motor 20, and the rear wheels are driven by the other. The controller 40 may select such a dual mode when traveling on a slippery road. Since it is a four-wheel drive, it becomes difficult to slip.

When driving with two-wheel drive and high torque, the controller 40 selects the dual mode. The controller 40 controls the first inverter 31 and the second inverter 32 such that the AC output of the first inverter 31 and the AC output of the second inverter overlap with each other in the first stator coil 11 of the first motor 10. By controlling the two inverters in this way, the first motor 10 outputs high torque with high utilization efficiency.

When driving with two-wheel drive and low torque, the controller 40 selects a single mode. The controller 40 drives one of the first inverter 31 and the second inverter 32 and stops the other. Since only one inverter and one motor are used, the utilization efficiency of the drive device 2 is increased.

### Second Embodiment

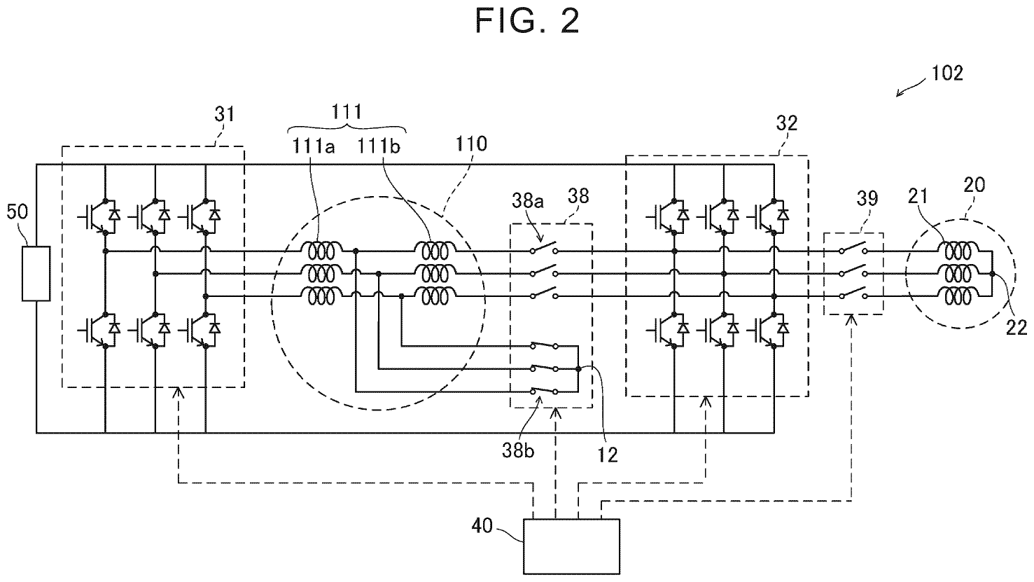

FIG. 2 is a circuit diagram of the drive device 102 according to the second embodiment. The drive device 102 differs from the first embodiment in the first motor 110. The configuration of the drive device 102 other than the first motor 110 is the same as that of the drive device 2 of the first embodiment.

The first stator coil 111 of the first motor 110 includes a first sub-coil 1111a and a second sub-coil 1111b connected in series. The first motor 110 includes a plurality of first stator coils 111, and includes a first sub-coil 1111a and a second sub-coil 1111b in which the plurality of first stator coils 111 are connected in series.

The first switch 38a of the changeover switch 38 is connected between the other end of the first stator coil 111 (the first sub-coil 1111a and the second sub-coil 1111b ) and the AC end of the second inverter 32. The second switch 38b is connected between the intermediate point of the first sub-coil 1111a and the second sub-coil 1111b and the neutral point 12. In the single mode, the intermediate point between the first sub-coil 1111a and the second sub-coil 1111b is connected to the neutral point 12. In the dual mode, the other end of the series-connected body of the first sub-coil 1111a and the second sub-coil 1111b is connected to the AC end of the second inverter 32. One end of the series-connected body of the first sub-coil 1111a and the second sub-coil 1111b is constantly connected to the AC end of the first inverter 31.

The case of driving the first motor 110 in the dual mode is the same as the case of the first embodiment. In other words, in the dual mode, a current flows through the series connecting member of the first sub-coil 1111a and the second sub-coil 1111b . When the first motor 110 is driven in the single mode, a current flows only in the first sub-coil 1111a in the first motor 110. In the single mode, since the number of windings of the first stator coil 111 of the first motor 110 is reduced, the inductance of the first motor 110 is lowered. Therefore, the first motor 110 can cope with a higher rotation band.

### Third Embodiment

The drive device 202 of the third embodiment will be described. In the drive device 202 of the third embodiment, the engine 204 and the planetary gear 250 are added to the drive device 2 of the first embodiment. The drive device 202 is adopted as a hybrid electric vehicle drive device.

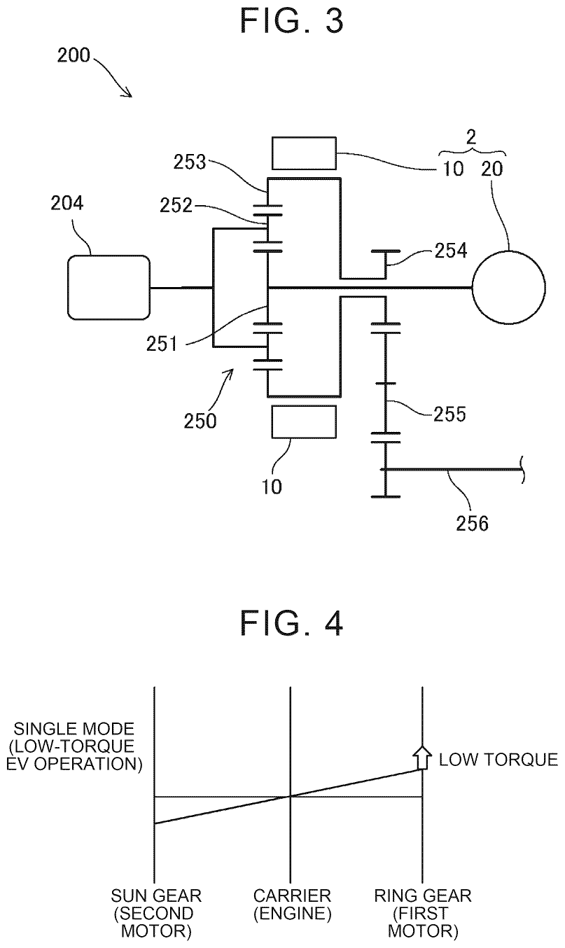

FIG. 3 shows a skeleton diagram of the drive device 202. In FIG. 3, only the first motor 10 and the second motor 20 are illustrated with respect to the drive device 2 of the first embodiment, and other components of the drive device 2 are not illustrated.

The planetary gear 250 includes a sun gear 251, a carrier 252, and a ring gear 253. A sun gear 251 is coupled to the output shaft of the second motor 20. A carrier 252 is coupled to the output shaft of the engine 204. A ring gear 253 is coupled to the output shaft of the first motor 10. In FIG. 3, the ring gear 253 is depicted as also serving as a rotor (i.e., an output shaft) of the first motor 10.

An output gear 254 is fixed to the ring gear 253, and the output gear 254 is engaged with the drive shaft 256 via an idle gear 255. A wheel (not shown) is coupled to the front of the drive shaft 256.

FIG. 4 to FIG. 6 show a collinear diagram of the drive device 202. FIG. 4 is a collinear diagram when EV running at low torques. The term “EV running” means a mode in which the engine is stopped and the engine is driven only by the motor. In contrast, “HV running” means running using both an engine and a motor. As can be seen from the skeleton diagram of FIG. 3, the number of revolutions of the ring gear of FIG. 4 is proportional to the number of revolutions of the axle.

For low-torque/EV running, the controller 40 selects a single mode. Then, the controller 40 stops the engine 204 and the second inverter 32, and drives the first motor 10 (the first inverter 31) (see FIG. 4). At this time, only the output torque of the first motor 10 contributes to the total output torque of the drive device 202.

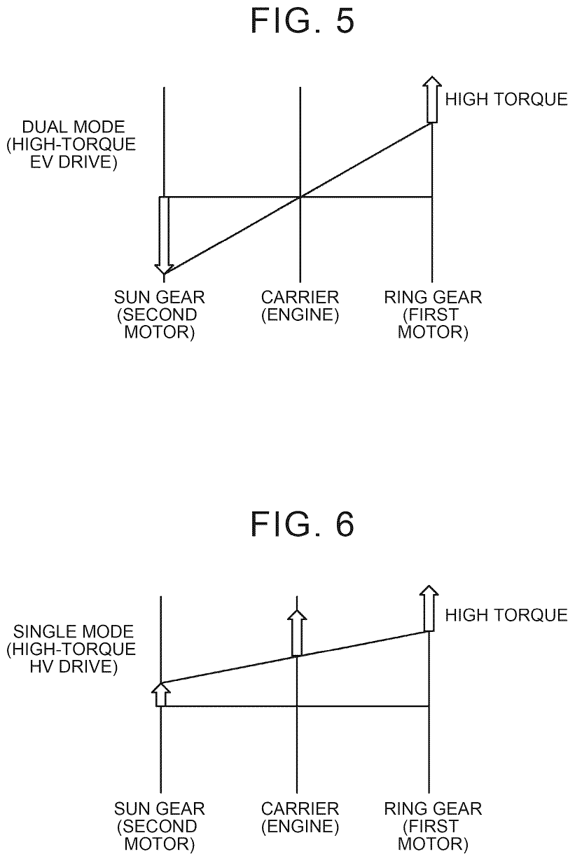

For high-torque/EV running, the controller 40 selects dual mode. Then, the controller 40 stops the engine 204 and drives the first motor 10 by the first inverter 31 and the second inverter 32 (see FIG. 5). At this time, the output torque of each of the first motor 10 and the second motor 20 contributes to the total output torque of the drive device 202.

For high-torque/HV running, the controller 40 selects a single mode. The controller 40 closes the interrupter switch 39. The controller 40 drives the engine 204, the first motor 10 (the first inverter 31), and the second motor 20 (the second inverter 32) (see FIG. 6). The controller 40 independently controls the first motor 10 (the first inverter 31) and the second motor 20 (the second inverter 32) according to the magnitude of the target torque. At this time, the output torque of each of the engine 204, the first motor 10, and the second motor 20 contributes to the total output torque of the drive device 202. The second motor 20 may be reversely driven by receiving a reaction force of the driving force of the first motor 10. At this time, the second motor 20 functions as a generator to generate electric power. The electric power obtained by the power generation is supplied to the first inverter 31 or stored in a battery.

As described above, the drive devices 2 and 102 of the embodiment can cope with high power utilization efficiency from low torque to high torque. The drive device 202 of the third embodiment can also cope with a high power utilization efficiency from a low torque to a high torque as in the case of the drive devices 2 and 102.

Points to be noted regarding the technique described in the embodiment will be described. The drive device 202 of the third embodiment may include a drive device 102 instead of the drive device 2. Further, the drive device 202 may be applied to machines other than hybrid electric vehicle. That is, in FIG. 3, instead of the drive shaft 256, another driven device may engage the output gear 254.

In the single mode, the controller 40 may not use the second motor 20 (the second inverter 32). When the second motor 20 (the second inverter 32) is not used in the single mode, the controller 40 may close or open the interrupter switch 39. When the interrupter switch 39 is opened, the second inverter 32 is shut off from the second motor 20, and the second motor 20 is not operated. If all the switching elements of the second inverter 32 are kept off even when the interrupter switch 39 is closed, the second motor 20 is not operated.

The features of the drive device of the embodiment will be described in more detail as follows. The first motor 10 includes a plurality of first stator coils 11, and the second motor 20 includes a plurality of second stator coils 21. Each of the first inverter 31 and the second inverter 32 includes a plurality of AC terminals. Each of the plurality of AC ends of the first inverter 31 is connected to one end of each of the plurality of first stator coils 11. The changeover switch 38 connects the other ends of the plurality of first stator coils 11 to one of the neutral point 12 and the alternating-current end of the second inverter 32, and disconnects them from the other. The plurality of second stator coils 21 are connected to the plurality of AC terminals of the second inverter 32, respectively. The interrupter switch 39 cuts off each of the plurality of second stator coils 21 from each of the plurality of AC ends of the second inverter 32.

In the dual mode, the controller 40 disconnects the other end of the first stator coil 11 from the neutral point 12 and connects to the AC end of the second inverter 32. The controller 40 disconnects the second stator coil 21 from the second inverter 32. In the single mode, the controller 40 disconnects the other end of the first stator coil 11 from the neutral point 12 and connects to the AC end of the second inverter 32.

In the drive device 102 of the second embodiment, the first stator coil 111 includes a first sub-coil 1111a and a second sub-coil 1111b . The first sub-coil 1111a and the second sub-coil 1111b are connected in series. The changeover switch 38 may switch between a first state and a second state. In the first condition, an intermediate point between the first sub-coil 1111a and the second sub-coil 1111b is connected to the neutral point 12, and the first sub-coil 1111a and the second sub-coil 1111b are disconnected from the second inverter 32. In the second condition, the other end of the first stator coil 111 (that is, the first sub-coil 1111a and the second sub-coil 1111b are connected in series) is connected to the AC end of the second inverter 32, and the first stator coil 111 is disconnected from the neutral point 12. The first state corresponds to a single mode and the second state corresponds to a dual mode. As described above, in the dual mode, the interrupter switch 39 is opened.

Although the specific examples of the present disclosure have been described in detail above, these are merely examples and do not limit the scope of claims. The techniques described in the claims include various modifications and alternations of the specific examples illustrated above. The technical elements described in the present specification or the drawings exhibit technical usefulness alone or in various combinations, and are not limited to the combinations described in the claims at the time of filing. In addition, the techniques illustrated in the present specification or drawings can achieve a plurality of objectives at the same time, and achieving one of the objectives itself has technical usefulness.

What is claimed is:

1. A drive device comprising:
a first motor equipped with a first stator coil;
a second motor equipped with a second stator coil;
a first inverter connected to the first stator coil;
a second inverter connected to the second stator coil;
a changeover switch for connecting the first stator coil to one of a neutral point and the second inverter;
an interrupter switch for disconnecting the second stator coil from the second inverter; and
a controller for controlling the changeover switch and the interrupter switch, wherein the controller switches between a dual mode in which the first stator coil is connected to the second inverter by the changeover switch and also the interrupter switch is opened, and a single mode in which the first stator coil is connected to the neutral point by the changeover switch.

2. The drive device according to claim 1, wherein:
the first stator coil includes a first sub-coil and a second sub-coil that are connected in series; and
the changeover switch connects an intermediate point between the first sub-coil and the second sub-coil to the neutral point.

3. The drive device according to claim 1, further comprising:
an engine; and
a planetary gear, wherein:
the first motor is coupled to a ring gear of the planetary gear;
the second motor is coupled to a sun gear of the planetary gear; and
the engine is coupled to a carrier of the planetary gear.
